(19) United States
(12) Patent Application Publication
(10) Pub. No.: US 2003/0204586 A1
(43) Pub. Date: Oct. 30, 2003

(54) Intelligent data replicator

(76) Inventor: Steve Schnetzler, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/133,714

(22) Filed: Apr. 25, 2002

(51) Int. Cl. G06F 15/173

(52) U.S. Cl. 709/224

(57) ABSTRACT

A method and apparatus to perform intelligent data replication is described.

### BACKGROUND

As more information is communicated over the Internet and World Wide Web (WWW), a class of technology is being developed to monitor communicated information for various applications. For example, a network administrator may desire to monitor customer traffic to ensure quality service by looking for errors in delivered web pages. Typically, the traffic may be replicated to a monitoring device. The monitoring device may then analyze the replicated information for errors or flaws. The sheer volume of customer traffic, however, may burden network resources in terms of memory, processing cycles and storage. As a result, a need may exist to monitor large volumes of information while reducing the impact on network resources.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention.

FIG. 2 is a block diagram of an intelligent data replicator (IDR) in accordance with one embodiment of the invention.

FIG. 3 is a block flow diagram of operations performed by an IDR in accordance with one embodiment of the invention.

### DETAILED DESCRIPTION

In this detailed description, numerous specific details are set forth in order to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

Embodiments of the invention may comprise a method and apparatus to perform intelligent data replication. An Intelligent Data Replicator (IDR) may be placed in a network to monitor information flow. The IDR may be configured to monitor for certain types of information. If the monitored information matches the configured type of information, the information may be selectively replicated to a monitoring device. Furthermore, the replication may be performed in a shared manner across output channels prior to communication to the client and the monitor. The sharing of replicated data between output channels may speed the replication and reduce performance cost. The monitoring device may then analyze the information using a set of predetermined criteria, and provide a report for use in identifying and correcting potential errors or flaws in the information. Consequently, the quality of information may be increased using potentially less network resources than conventional techniques. Accordingly, a network administrator may improve the delivery of web site content to a user.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

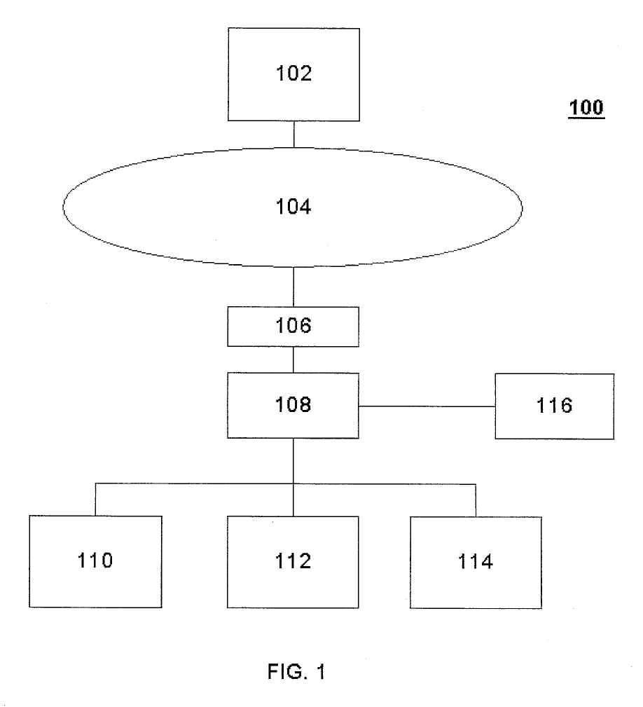

Referring now in detail to the drawings wherein like parts are designated by like reference numerals throughout, there is illustrated in FIG. 1 a system suitable for practicing one embodiment of the invention. FIG. 1 is a block diagram of a system 100 comprising a number of network nodes. The term “network nodes” as used herein may refer to any device or application configured to communicate information to another device or application. Examples of a network node may comprise a personal computer (PC), portable computer, server, router, switch, network appliance and so forth.

In one embodiment, system 100 may comprise network nodes 102, 106, 108, 110, 112, 114 and 116. Each network node may be configured with the appropriate hardware and software for communicating information between each other in the form of packets over any type of communication media. Communication media may include, for example, twisted-pair wire, co-axial cable, fiber optics, radio frequencies and so forth. A packet may comprise, for example, a discrete set of information. The packets may be sent in accordance with any number of network protocols, such as the Transmission Control Protocol (TCP) as defined by the Internet Engineering Task Force (IETF) standard 7, Request For Comment (RFC) 793, adopted in September, 1981, and the Internet Protocol (IP) as defined by the IETF standard 5, RFC 791, adopted in September, 1981 (“TCP/IP Specification”), both available from “www.ietf.org.” Although a limited number of network nodes are shown for purposes of clarity, it can be appreciated that system 100 may comprise any number of network nodes and still fall within the scope of the invention.

In one embodiment of the invention, network node 102 may comprise a personal computer equipped with browser software. Node 102 may communicate with node 106 via a network 104. Node 106 may comprise, for example, a network appliance such as a Secure Socket Layer (SSL) encrypting/decryption device. Network 104 may comprise a packet network having any number of network nodes.

Node 106 may be connected to a network node 108. Network node 108 may comprise, for example, a load balancer. A load balancer may distribute network traffic among multiple network nodes, such as servers in a “server farm.” In one embodiment of the invention, the load balancer may be a Traffic Director product made by Intel Corporation, for example.

Node 108 may be connected to network nodes 110, 112 and 114. In one embodiment of the invention, network nodes 110, 112 and 114 may be servers that collectively may be referred to as a Storage Area Network (SAN) or server farm. The servers may store information in the form of electronic files in accordance with any number of formats. For example, in one embodiment of the invention the information is stored as Hypertext Markup Language (HTML) or Extensible Markup Language (XML) files.

Node 108 may also be connected to a network node 116. In one embodiment of the invention, node 116 may be a monitoring node. The monitoring node may receive monitored information from node 108. The type of received information may include information matching a particular pattern or filter set of criteria. The pattern may include text, alphanumeric characters, symbols, mathematical operators, images, file types and any other characteristics of electronic information, for example. The received information may then be analyzed and used to improve errors or flaws in the received information.

In general operation, a client at node 102 may activate the browser software to establish a connection to one of network nodes 110, 112 and 114. The connection may be established using any number of Internet or WWW protocols, such as the Hypertext Transfer Protocol (HTTP) and the TCP/IP Specification. Further, the connection may be a secure connection where information is sent in encrypted form according to a security protocol. An example of a secure connection may include a SSL connection. The user at node 102 may request information from a web site identified by a Uniform Resource Locator (URL), such as “www.acme.com.” The information may be an HTML or XML file, such as a file identified as “acmeinfo.htm.” The file “acmeinfo.htm” may be stored on one or more servers 110, 112 and/or 114. The SSL device may receive and decrypt the encrypted information received from node 102, and forward the decrypted information to node 108. The load balancer may receive the decrypted client request and direct it to one of servers 110, 112 and/or 114 based on any number of load balancing algorithms. The load balancer may also perform a monitoring and switching function referred to herein as Intelligent Data Replication. For example, the load balancer may include an Intelligent Data Replicator (IDR) to compare the request and/or information sent in response to the request to a pattern or filter. If the request and/or information match a certain pattern or filter, the load balancer may forward the information to the monitoring node. The monitoring node may then process the forwarded information for any number of purposes, such as error detection, error correction, quality assurance and so forth.

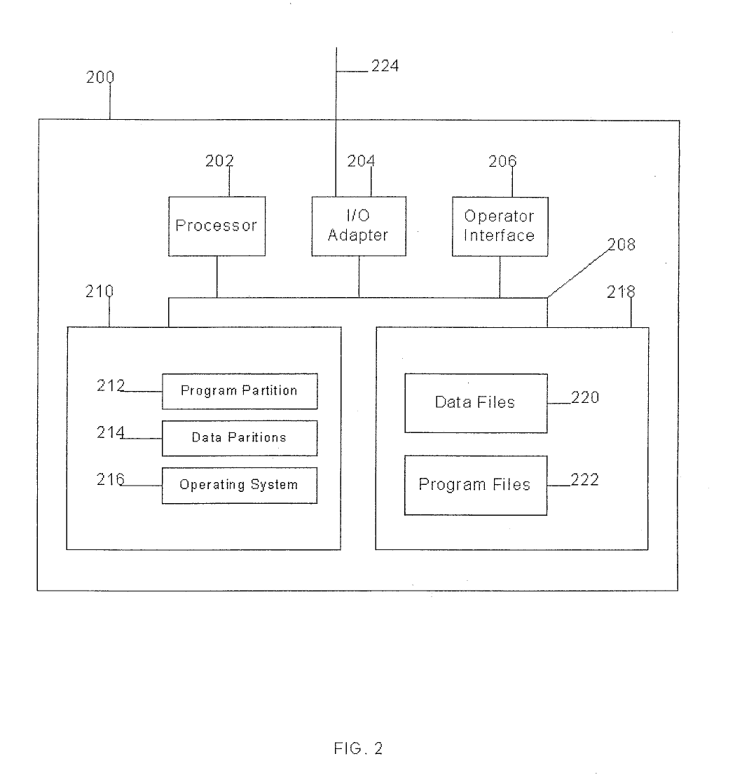

FIG. 2 illustrates an IDR in accordance with one embodiment of the invention. FIG. 2 illustrates an IDR 200. In this embodiment, IDR 200 may be representative of any of the devices shown as part of system 100. As shown in FIG. 2, IDR 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or network interfaces that can connect to local or wide area networks such as, for example, the network described in FIG. 1. Therefore, connection 224 represents a network or a direct connection to other equipment.

Processor 202 can be any type of processor capable of providing the speed and functionality required by the embodiments of the invention. For example, processor 202 could be a processor from family of processors made by Intel Corporation, Motorola Incorporated, Sun Microsystems Incorporated, Compaq Computer Corporation and others.

In one embodiment of the invention, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment of the invention, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, IDR 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment of the invention, operating system 216 may comprise an operating system sold by Microsoft Corporation, such as Microsoft Windows® 95, 98, 2000 and NT, for example. Program partition 212 stores and allows execution by processor 202 of program instructions that implement the functions of each respective system described herein. Data partition 214 is accessible by processor 202 and stores data used during the execution of program instructions. For IDR 200, program partition 212 may contain program instructions that will be collectively referred to herein as an IDR module. This module may perform monitoring, pattern matching and replication functions, as described herein. Of course, the scope of the invention is not limited to this particular set of instructions.

I/O adapter 204 may comprise a network adapter or network interface card (NIC) configured to operate with any suitable technique for controlling communication signals between computer or network devices using a desired set of communications protocols, services and operating procedures, for example. In one embodiment of the invention, I/O adapter 204 may operate, for example, in accordance with the TCP/IP Specification and HTTP, although the embodiments are not limited in this respect. I/O adapter 204 also includes appropriate connectors for connecting I/O adapter 204 with a suitable communications medium. I/O adapter 204 may receive communication signals over any suitable medium such as copper leads, twisted-pair wire, co-axial cable, fiber optics, radio frequencies, and so forth.

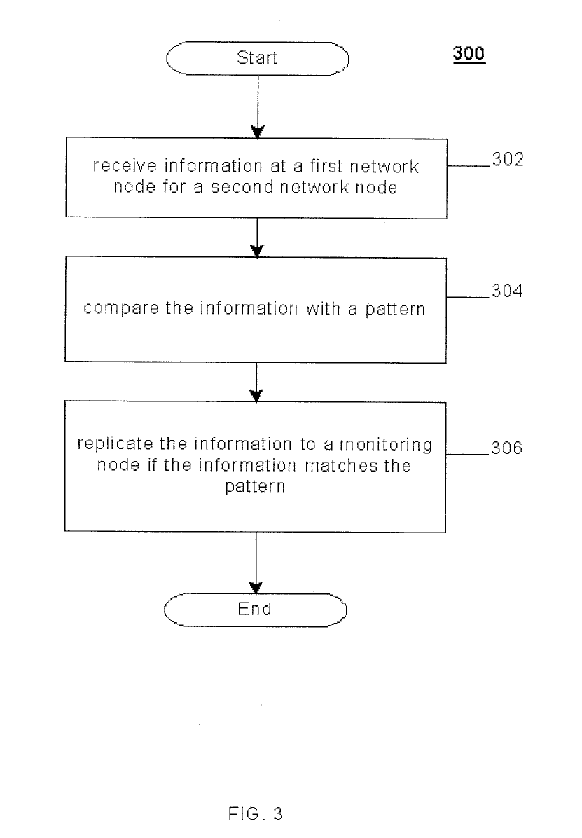

The operations of systems 100 and 200 may be further described with reference to FIG. 3 and accompanying examples. Although FIG. 3 as presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 3 is a block flow diagram of the programming logic performed by an IDR module in accordance with one embodiment of the invention. In one embodiment of the invention, the IDR module may refer to the software and/or hardware used to implement the functionality for Intelligent Data Replication as described herein. In this embodiment of the invention, the IDR module may be implemented as part of node 108. It can be appreciated that this functionality, however, may be implemented by any device, or combination of devices, located anywhere in a communication network and still fall within the scope of the invention.

As shown in FIG. 3, processing logic 300 may illustrate a process to monitor information. Information may be received at a first network node for a second network node at block 302. The information may be compared with a pattern at block 304. The information may be replicated to a monitoring node if the information matches said pattern. The information may also be forwarded to the client as well before or after replication to the monitoring node.

In one embodiment of the invention, the pattern may represent a set of predetermined criteria related to HTML or XML documents. The pattern may include text, alphanumeric characters, symbols, mathematical operators, images, file types and any other characteristics of electronic information, for example. An example of a pattern may include a reference to a specific string of characters, such as “www.acme.com.” In this example, all information communicated between a client and the server hosting “www.acme.com” may be replicated to a monitoring node, such as monitoring node 116. In another example, a pattern may include generically all “.htm” files, or a specific file such as “acmeinfo.htm.” In yet another example, the pattern may include specific information denoted by any HTML or XML identifier. Through the use of a pattern, the embodiments can selective replicate information communicated between certain points to a monitoring node. This selective replication increases monitoring efficiency while reducing use of network resources, such as memory, processing cycles or storage, for example.

In one embodiment of the invention, the monitored information may be in encrypted form. In this case, the information may be decrypted prior to pattern matching by node 106, for example.

The type of information monitored may be any type of information. For example, the information may include control information used to set up connections. In this example, HTTP “get” requests and other HTTP control messages may be part of the pattern. In another example, the information may be payload information, which is defined herein to include all non-control information. An example of payload information may include content from an XML or HTML document or file.

Once the information is replicated to a monitoring node, the monitoring node may process the information for use in any application. For example, the monitoring node may analyze the information in accordance with a set of predetermined criteria, such as error counts, response times, segment size and so forth. The analyzed information may be used to update the web site or web site content to improve quality or delivery of information in the future.

The operation of system 100, system 200 and the processing logic described with reference to FIG. 3 may be better understood by way of example. Assume nodes 106, 108, 110, 112 and 114 are part of a web server array, with node 106 operating as an SSL device, node 108 operating as a load balancer with and IDR module, and nodes 110, 112 and 114 operating as host servers. In this example, node 108 may represent an intermediate node between a client and a server. Node 116 may operate as a monitoring node, and be in communication with node 108.

An administrator for the web server array wants to monitor HTML information for the domain “acme.com” hosted on node 110. The administrator may configure the IDR module of node 108 with the following XML pattern:

<dmtap>

<add>

<matchSet>

<filter>

<request>

<vip>acme.com</vip>
<xmlExpr>*.html</xmlExpr>
<xmlExpr>Product=widget</xmlExpr>

</request>

</filter>
<action>

<capture>

</action>

</matchSet>

</add>

</dmtap>

Node 108 may use the XML pattern to monitor the information flow between node 110 and any client nodes, such as node 102, and send any HTML requests and responses to the domain “acme.com” to node 116. More particularly, node 102 may send an encrypted request for a TCP connection to server 110 to access the domain “acme.com.” The encrypted TCP request is received by node 106 and decrypted. Node 106 sends the decrypted TCP request to node 108. Node 108 may decode a Global User Identifier (GUID) that may have already been given the browser of node 102 via a cookie or URL query method. A GUID may be a unique identifier for a browser. The GUID may be used to count how many clients are using a site, and differentiate what each one is doing. If a GUID is not found, node 108 may create a GUID for the browser of node 102.

The IDR module of node 108 receives the TCP request and compares it to the XML pattern shown above. Any type of pattern matching algorithm may be utilized for the comparison based on various criteria, such as the size of the XML pattern, the volume of information being monitored, hardware configuration, latency requirements and so forth. In this example, the IDR module may scan the TCP request and determine whether the request is for the “acme.com” domain specified by the XML pattern. It also attempts to determine whether the URL is for the URL filter (i.e., *.html) specified by the XML pattern. Further, the IDR module may also scan the body of the TCP request for any other filters, such as the product filter (i.e., Product=Widget) specified by the XML pattern above. If the TCP request matches some or all of the XML pattern requirements, the IDR module may forward the TCP request, the GUID for the browser and a time stamp to node 116. It can be appreciated that these are examples of pattern criteria and any type of markup expression or criteria may be used for a pattern and still fall within the scope of the invention.

Node 108 also forwards the processed TCP request to server 110. Server 110 may send a response header. The response header may be compared to the XML pattern to determine a match. If there is a match, the IDR may forward the response header, the GUID and a time stamp to node 116. Alternatively, the response header may have been sent in response to a previously matched TCP request. In this case, the IDR module may send the response header and relevant information to node 116 without performing the matching process. Node 108 may then forward the response header to node 106 for encryption. Node 106 may then forward the encrypted response header to the browser of node 102.

Once the connection between node 102 and node 110 has been established, node 110 may begin streaming information to node 102 via node 108. Node 108 may receive the streaming information from server 110. The IDR module of node 108 may compare the XML pattern with the streaming information to determine whether any of the response filters in the XML pattern are matched. For example, the XML pattern may have a response filter that attempts to identify any responses containing image files, audio files or video files. If there is a match, the IDR module may send the response and the GUID to node 116. As with the response header, the streaming information may have been sent in response to a previously matched TCP request or response header. In this case, the IDR module may send all or part of the streaming information and other relevant information to node 116 without performing the matching process. Node 108 may then forward the streaming information to node 106 for encryption. Node 106 may then forward the encrypted information to the browser of node 102.

With any of the above cases, the IDR module of node 108 may check incoming information to determine whether errors have occurred. For example, node 108 may detect and HTTP error associated with a response header. If the response header matches the XML pattern, or is in response to a previously matched TCP request, node 108 may forward the response header, HTTP error identifier, GUID and time stamp to node 116. Node 108 may then select another server hosting the monitored domain and attempt to coordinate delivery of the requested information to the browser of node 102 and node 116. This process may also apply for errors detected for the TCP request and streaming information.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to monitor information, comprising:
receiving information at a first network node for a second network node;
comparing said information with a pattern; and
replicating said information to a monitoring node if said information matches said pattern.

2. The method of claim 1, wherein said pattern is an Extensible Markup Language pattern.

3. The method of claim 1, further comprising decrypting said information prior to said comparing.

4. The method of claim 1, wherein said information comprises layer seven information.

5. The method of claim 1, wherein said information comprises an Extensible Markup Language document.

6. The method of claim 1, further comprising sending said information to said second network node.

7. The method of claim 1, further comprising:
receiving said information at said third network node;
analyzing said information in accordance with a set of predetermined criteria; and
updating said information in accordance with said analysis.

8. A system to monitor information, comprising:
a server to send information to a client;
a monitoring node to monitor information; and
an intermediate node having an IDR module to intercept said information and determine whether to replicate said information to said monitoring node.

9. The system of claim 8, wherein said intermediate node also performs load balancing.

10. The system of claim 8, further comprising a decrypting node to decrypt said information prior to interception by said intermediate node.

11. An apparatus to monitor information, comprising:
a document object generator to receive information and generate a document object;
a pattern object generator to receive a pattern and generate a pattern object; and
switching logic to compare said document object to said pattern object, and to switch said information to a monitoring node if said document object matches said pattern object.

12. The apparatus of claim 11, wherein said information comprises an Extensible Markup Language document.

13. The apparatus of claim 11, wherein said pattern comprises an Extensible Markup Language pattern.

14. The apparatus of claim 11, wherein said switching logic uses a pattern matching algorithm to compare said document object and said pattern object.

15. An article comprising:
a storage medium;
said storage medium including stored instructions that, when executed by a processor, result in monitoring information by receiving information at a first network node for a second network node, comparing said information with a pattern, and replicating said information to a monitoring node if said information matches said pattern.

16. The article of claim 15, wherein the stored instructions, when executed by a processor, further result in decrypting said information prior to said comparing.

17. The article of claim 15, wherein the stored instructions, when executed by a processor, further result in sending said information to said second network node.

18. The article of claim 15, wherein the stored instructions, when executed by a processor, further result in receiving said information at said third network node, analyzing said information in accordance with a set of predetermined criteria, and updating said information in accordance with said analysis.
